(19) United States
(12) Patent Application Publication
(10) Pub. No.: US 2006/0048012 A1
(43) Pub. Date: Mar. 2, 2006

(54) Context sensitive debug streams with output throttling controls

(75) Inventors: Christopher Mark Barton, Edmonton (CA); Arie Tal, Toronto (CA)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/929,183

(22) Filed: Aug. 30, 2004

(51) Int. Cl. G06F 11/00

(52) U.S. Cl. 714/38

(57) ABSTRACT

A method, apparatus, and computer program product for using debug streams to control the amount of trace outputs when debugging software. As debug streams extend on the use of regular output streams, debug streams are very easy to use and simple to implement, while providing a high level of control over the verbosity of traces. A debug stream is created that includes a debug level setting to control the verbosity of the trace outputs. A determination is made as to whether the debug level setting in the debug stream is greater than a specified threshold level. Responsive to a determination that the debug level setting is greater than the specified threshold level, trace outputs are emitted to the debug stream.

### BACKGROUND OF THE INVENTION

1. Technical Field

The present invention relates generally to an improved data processing system. In particular, the present invention relates to a method, apparatus, and computer instructions for controlling the amount of trace outputs when debugging software.

2. Description of Related Art

Effective management and enhancement of data processing systems requires knowing how and when various system resources are being used. Performance tools are used to monitor and examine a data processing system to determine resource consumption as various software applications are executing within the data processing system. For example, a performance tool may identify the most frequently executed modules and instructions in a data processing system, or may identify those modules which allocate the largest amount of memory or perform the most I/O requests. Hardware performance tools may be built into the system or added at a later point in time. Software performance tools also are useful in data processing systems, such as personal computer systems, which typically do not contain many, if any, built-in hardware performance tools. Most modern personal computer systems (i.e., desktops and laptops) contain some type of hardware performance counters, although these hardware performance counters are generally not as extensive as those found in high-end machines.

Tracing (also known as “debug” printing) is a common technique for simplifying the development and support processes of software products. Many products, including the XL Compilers, a family of compiler products of International Business Machines Corporation (IBM), require and contain extensive tracing capabilities. A tracer may use more than one technique to provide trace information that indicates execution flows for an executing program. One technique keeps track of particular sequences of instructions by logging certain events as they occur, so-called event-based profiling technique. For example, a tracer may log every entry into, and every exit from, a module, subroutine, method, function, or system component. Alternately, a tracer may log the requester and the amounts of memory allocated for each memory allocation request. Typically, a time-stamped record is produced for each such event. Corresponding pairs of records similar to entry-exit records also are used to trace execution of arbitrary code segments, starting and completing I/O or data transmission, and for many other events of interest.

Another trace technique involves periodically sampling a program's execution flows to identify certain locations in the program in which the program appears to spend large amounts of time. This technique is based on the idea of periodically interrupting the application or data processing system execution at regular intervals, so-called sample-based profiling. At each interruption, information is recorded for a predetermined length of time or for a predetermined number of events of interest. For example, the program counter of the currently executing thread, which is a process that is part of the larger program being profiled, may be recorded during the intervals. These values may be resolved against a load map and symbol table information for the data processing system at post-processing time, and a profile of where the time is being spent may be obtained from this analysis.

The most common problem encountered with tracing is the “you can't see the forest for the trees” problem. In other words, when too much information is produced by the tracing facilities, it is difficult (and sometimes nearly impossible) for the software developer to locate the relevant part of the trace in the stream. In addition, even when that part of the trace is located, it may still contain too much information to be of any use. A software developer may often desire to qualify the profiling of an application through various types of conditions that may exist within the execution environment of the application program being profiled. For example, a software developer may desire to limit the generation of trace data so that trace data is only generated during periods of time in which a specific condition is active. This type of granularity would allow a software developer to obtain a more focused picture of the execution conditions within the profiled application.

Existing methods of addressing the problem above provide a set of tracing controls that allow developers to minimize the trace output by specifying which part of the trace they want to see. Such methods may be implemented in, for example, the Toronto Portable Optimizer (TPO), which is used by the IBM XL family of compilers for language-independent optimizations using an intermediate stack language called W-code. W-code and W-code based optimizers provide a comprehensive optimization and analysis infrastructure. Other products address the problem above by allowing an output threshold to be set by the tracers (i.e., developers or maintainers), and thus set the “level of noise” as they need it.

However, as most software products are written to reuse code, a part of the code providing a particular functionality may be called from other parts of the code multiple times. Even though the trace output for the code providing the particular functionality is enabled, it may still be difficult (and sometimes impossible) to determine from where in the code the particular functionality was activated. In addition, it may be difficult to determine if the trace output actually generated is the output (and the level of output) that the tracer required. Although locating the part of the code from where the particular functionality was activated may be achieved using a combination of global and local trace flags, this approach requires strict discipline on the part of the developer to keep track of the tracing state, as well as presents additional problems with concurrent activations.

Therefore, it would be advantageous to provide a method and apparatus that reduces the amount of data generated during tracing. It would be particularly advantageous to provide the ability to selectively enable context sensitive tracing.

### SUMMARY OF THE INVENTION

The present invention provides a method, apparatus, and computer program product for using debug streams to control the amount of trace outputs when debugging software. As debug streams extend on the use of regular output streams, debug streams are very easy to use and simple to implement, while providing a high level of control over the verbosity of traces. A debug stream is created that includes a debug level setting to control the verbosity of the trace outputs. A determination is made as to whether the debug level setting in the debug stream is greater than a specified threshold level. Responsive to a determination that the debug level setting is greater than the specified threshold level, trace outputs are emitted to the debug stream.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a distributed data processing system in which the present invention may be implemented;

FIG. 2 is a block diagrams depicting a data processing system in which the present invention may be implemented;

FIG. 3 is a block diagram depicting a data processing system in which the present invention may be implemented;

FIG. 4 is a block diagram depicting exemplary components within a known compiler system in which the present invention may be implemented;

FIGS. 5-6 are exemplary program execution sequences for modifying debug stream levels in accordance with a preferred embodiment of the present invention;

FIG. 7 is an exemplary program execution sequence for allowing direct access to the output stream in accordance with a preferred embodiment of the present invention;

FIG. 8 is an exemplary program execution sequence for determining whether a debug stream is enabled for performance considerations in accordance with a preferred embodiment of the present invention;

FIG. 9 is an exemplary program execution sequence for providing specialized trace streams in accordance with a preferred embodiment of the present invention; and

FIG. 10 is a flowchart depicting a process for using debug streams to control the amount of trace outputs in accordance with a preferred embodiment of the present invention.

### DETAILED DESCRIPTION OF THE PREFERRED EMBODIMENT

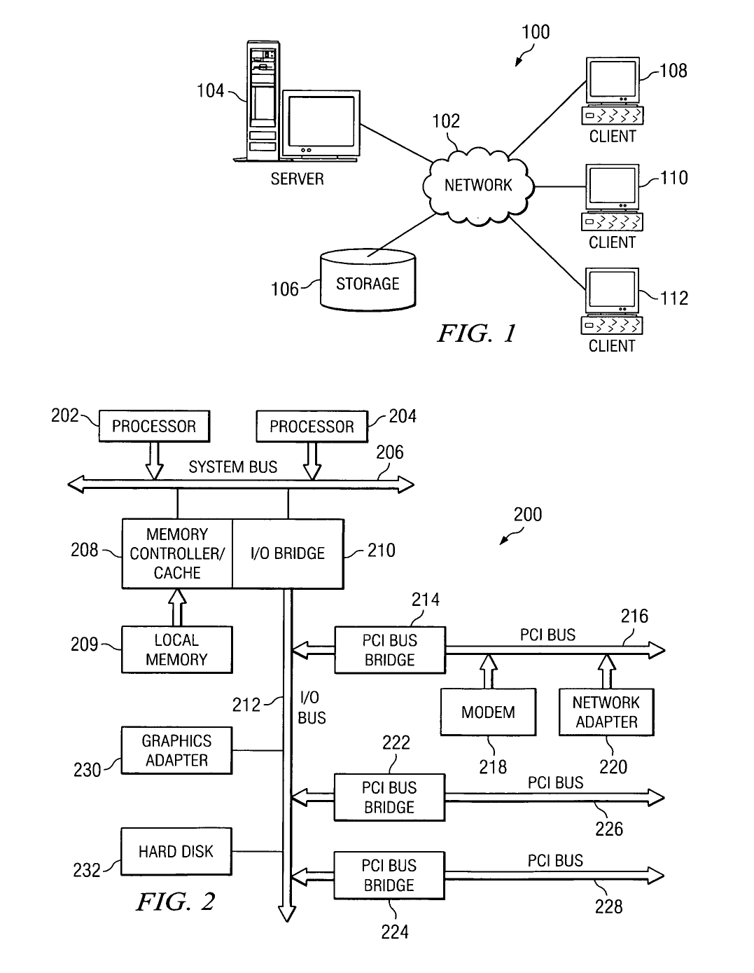

With reference now to the figures, FIG. 1 depicts a distributed data processing system in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral Component Interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive™ (AIX) operating system or Linux™ operating system.

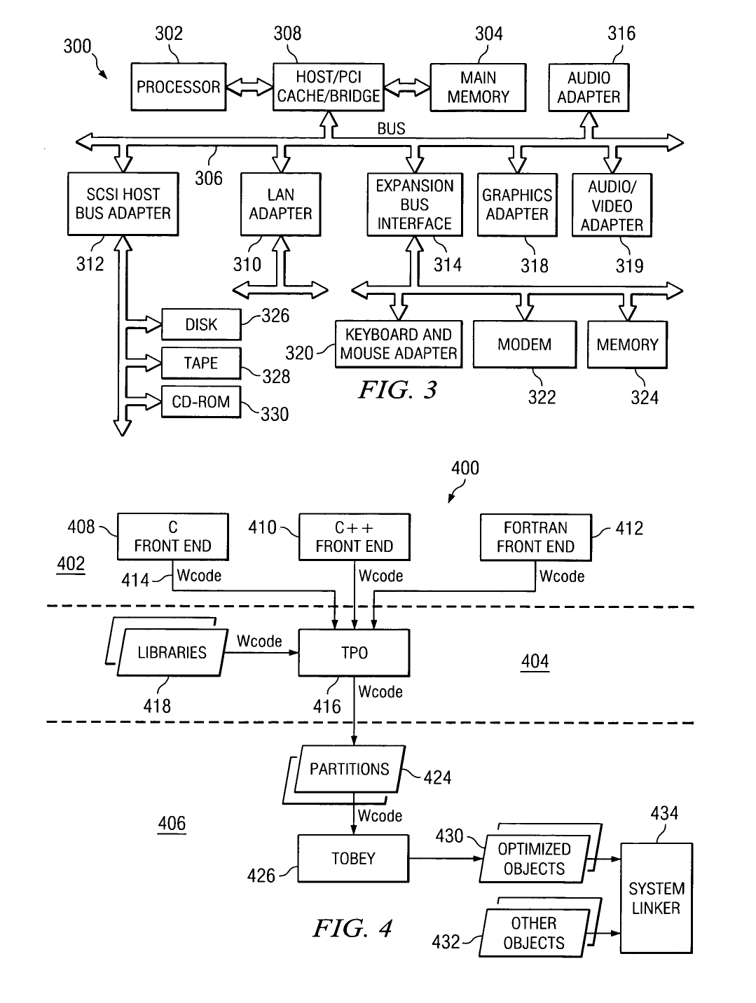

With reference now to FIG. 3, a block diagram illustrating a data processing system is depicted in which the present invention may be implemented. Data processing system 300 is an example of a client computer. Data processing system 300 employs a Peripheral Component Interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

The present invention provides a tracing technique for simplifying the development and support of software products. In one exemplary embodiment of the present invention, this tracing technique is performed using the IBM XL family of compilers, which provide optimization and functionality delivered on various platforms to C/C++/Fortran programming languages.

FIG. 4 is a block diagram depicting exemplary components within a known compiler system in which the present invention may be implemented. Compiler system 400 shows an XL C/C++/Fortran compiler system. Compiler system 400 takes a source program (e.g., written in C/C++/Fortran) and translates it into code that will run natively on a specific machine. During the translation, optimizations are performed on the source code to make it run more efficiently. Executable code is generated from source code, using compiler system 400. During compilation (the translation of source code to executable code), the program is optimized to make it run more efficiently. TPO is one component in the XL Compilers that performs optimizations.

To enable a particular source code program to execute on different types of data processing systems, a compiler typically generates an architecture-neutral file format, such as W-code. W-code is a machine independent code and is nonspecific to a particular computer architecture. W-code is an Intermediate Language (IL) and is used to represent the source program internally in the compiler. W-code is also used to transfer information about the source program between components of the XL Compilers (i.e., Front end ->TPO, TPO ->TOBEY). Thus, the output from one component must generate W-code and the input into another component must read/decode W-code. This simplifies the compilation process because all components recognize a common format. While W-code is architecture independent, it is not executable; it is a strictly well-defined representation for the source code that all components recognize.

The compiler generates an executable program that will run on a specific architecture. This executable can either run natively (i.e., the machine recognizes the instructions in the program and can run them itself) or run through an interpreter (i.e., another program reads the instructions in the program and executes them). In the case of C/C++/Fortran, executable machine code is generated. In the case of Java, bytecodes are generated, which must be run through an interpreter (the Java Virtual Machine).

A typical optimization scenario comprises a front-end 402, an optimization layer 404, and a back-end 406. Front-end 402 comprises multiple language specific front-ends, such as C language front-end 408, C++ language front-end 410, and Fortran language front-end 412. Each front-end component, 408, 410, 412, translates the corresponding source code program into a high-level intermediate language, such as W-code 414. W-code 414 is used to provide an intermediate representation of the particular source code.

Optimization layer 404 comprises a Toronto Portable Optimizer (TPO) 416 and libraries 418. TPO 416 receives and generates intermediate representations in W-code. TPO 416 performs language and architecture independent optimizations, such as constant propagation and dead code elimination, and also high-level loop transformations based on aggressive dataflow analysis. Libraries 418 are commonly used functions that may be called from a program. The object code for these functions reside in a separate files and must be available in order to create an executable program.

Components in the back-end 406 receive the optimized program in the form of W-code from TPO 416. The transformed W-code is converted into optimized machine code by an architecture-specific back-end. As shown, the back-end 422 comprises W-code partitions 424, Toronto Optimizing Back End with Yorktown (TOBEY) compiler 426, optimized objects 430, other objects 432, and system linker 434. TOBEY 426, which is a highly optimizing code generator for PowerPC targets, is used to translate the optimized source code from TPO (in the form of W-code) into machine code. TOBEY 426 implements architecture and implementation specific optimizations and generates the actual executable code, e.g., POWER/PowerPC executable code. Optimized objects 430 are the output of TOBEY. Object files contain the optimized machine code created by TOBEY. Other objects 432 are additional object files not created by TOBEY, but are necessary to compile the program successfully. For example, other objects 432 may include libraries that are used by the source program. System linker 434 puts all of the object files together and creates the final executable.

With the present invention, debug streams are used to control the verbosity of trace output streams when debugging software. Verbosity is the level of detail of the debug messages being printed. A higher verbosity level will result in more detailed messages, resulting in more information being printed. Similarly, a lower verbosity level results in less detailed messages, resulting in less information being printed.

Debug streams are a controlled imitation of output streams. Specifically, debug streams are C++ objects that wrap around regular output streams (ostream) or an output file. A wrapper is a piece of code that wraps or abstracts the use of another piece of code. Rather than using debug stream objects as subclasses for output streams, the debug stream objects are created as wrappers for output streams to enable controlling the output (e.g., when to print, the level to print, etc.) to the real streams.

In order to control the underlying trace output, the present invention employs constructors to build a debug stream wrapped around a specified underlying output stream. When a DebugStream( ) constructor creates a debug stream instance, the debug stream is assigned a debug control option, which is expressed as a string. The presence of a debug control option enables the debug stream.

Different DebugStream( ) constructors may be used to generate a specified trace output. For example, a developer may select a DebugStream( ) constructor that creates a debug stream, specifies a debug control option (as a string), and supplies a trace output stream. The default setting for a standard trace output is “cout”. As DebugStream( ) constructors are written in the code (i.e., added when the code is being developed), a decision should be made during development of which constructor to use.

Another constructor that may be used is a DebugStream( ) constructor that creates a debug stream, specifies a debug control option (as a string) and specifies a file name. The file name specified will be used to create a file and write the trace output to the file. The file is created for writing when the debug stream object is constructed, and closed when the object is deleted.

A third constructor that may be used is a DebugStream( ) constructor that creates a debug stream, specifies a debug control option (as a string) and specifies a DebugStream controller object. Specifying a DebugStream controller object allows the output on this debug stream to be enabled if both its debug control option is enabled and the debug stream object is enabled. This debug constructor allows for creating greater context sensitiveness beyond the absolute debug levels. In this manner, a developer may be able to trace specific parts of a code that is being generally traced, as described below.

Once a DebugStream has been constructed, the output stream can be accessed directly using the mOS member of the DebugStream object. The mOS member of a debug stream is a pointer to the actual output stream, which causes this invocation to call the original output function in a way that is controlled by the debug stream framework. The mOS command allows direct access to the output stream when needed.

Furthermore, threshold levels may be set in the debug stream to allow only specified outputs to be emitted to the output stream. The current threshold level of the debug stream may be obtained using using a GetThresholdLevel( ) method. GetThresholdLevel( ) is a method for querying the current threshold level of the debug stream. SetThresholdLevel( ) is a method for setting the current threshold level of the debug stream. A threshold level is set in order to only allow outputs with an acceptable debug level. A threshold can be set for the entire stream (i.e., trace).

A debug level may be set to allow for the output of specific trace messages, such as printing a single line. A DebugLevel class is provided to allow for temporarily modifying the debug level of a debug stream.

A DebugLevel object is constructed given a DebugStream object and a new debug level setting. The DebugLevel object then queries the DebugStream object for its current debug level. This step may be performed using a GetDebugLevel( ) method. GetDebugLevel( ) is a method for querying the current debug level setting for outputs to the debug stream. Once the current debug level is obtained, the DebugLevel object retains the current debug level and sets the DebugStream object's debug level to the new setting. This step may be performed using a SetDebugLevel( ) method. SetDebugLevel( ) a method for setting the current debug level setting for outputs to the stream. In this manner, trace outputs having a debug level higher than the threshold will not be emitted to the output stream. When the DebugLevel object is deconstructed, it restores the retained debug level setting in the DebugStream object.

A DebugStream object may be passed to any code providing some common functionality. If the DebugStream object is used by a high level stage of the compiler, for example, the object is controlled by that stage's trace control. Although the code outputs its traces to the DebugStream object, the code is oblivious to whether the debug stream is enabled or not. The traces for the provided functionality will only be enabled if the high level stage required it.

With debug streams, there is no need to pass trace flags, manage their contexts, or manage different output streams (to files, to console, to error stream, etc.). The level of convenience and control offered by using debug streams are such that, for example, every loop optimization transformation in the TPO is automatically set up with its own analysis stream and transformation stream, with separate threshold controls for each. In this manner, debug streams give a developer a greater and much more granular control over compiler traces.

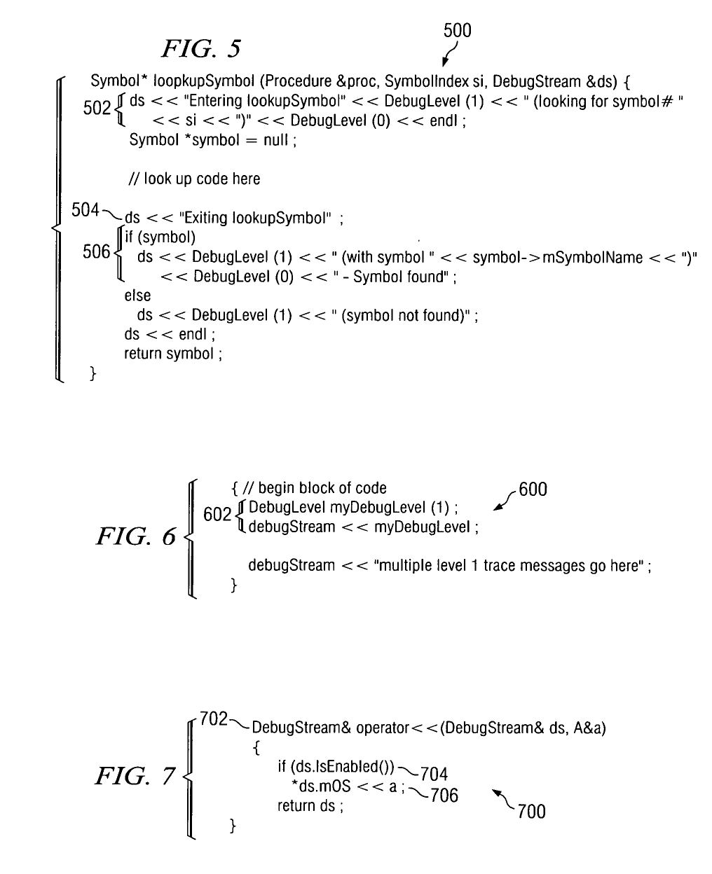

FIGS. 5-6 are exemplary program execution sequences for modifying debug stream levels in accordance with a preferred embodiment of the present invention. In particular, the example program in FIG. 5 uses a lookupsymbol( ) routine to illustrate using DebugLevel objects to temporarily modify the debug stream's debug level setting.

In this illustrative example, lookupSymbol( ) routine 500 is used to determine a symbol for a function or global variable. LookupSymbol( ) routine 500 may be called from multiple places to provide its functionality. In this particular example, lookupSymbol( ) routine 500 is called with an enabled debug stream.

If the DebugStream is enabled with a threshold greater than or equal to 0, the text “Entering lookupSymbol” and “Exiting lookupsymbol” will be printed (step 502 and 504 respectively). The text “-Symbol found” may also be printed depending on whether the symbol was found (e.g., the symbol object is not NULL in the first line of 506). If the DebugStream is enabled with threshold greater than or equal to 1, the text “(looking for symbol# SymbolNumber)” will be printed, where SymbolNumber is the symbol number, determined during program execution. The text “(with symbol SymbolName)” or “(symbol not found)”, will also be printed depending on the symbol object. SymbolName is the name of the symbol, determined at runtime. The use of DebugLevels in this example demonstrates the easy modification of the thresholds used by DebugStreams within a single use of a DebugStream object.

Each time a DebugLevel object is used as in the above example (i.e., DebugLevel objects are constructed as temporary objects), the DebugLevel object survives only until the end of the line of code, as defined by the C++ standard. Consequently, the debug level setting modification is temporary. Therefore, upon construction, the temporary object will remember the current debug level of the debug stream, modify it, and restore it upon deconstruction, as previously described. Since the multiple DebugLevel objects are deconstructed in a reverse order to their creation order, we are assured that the original debug level setting for the debug stream will be restored.

FIG. 6 illustrates an example program sequence for temporarily setting a debug level for a block of code containing multiple trace messages. When the block of code 600 begins, the debug level object “myDebugLevel(1)” is set to the debug stream in step 602. When the block ends, the myDebugLevel object gets automatically destroyed, restoring the original debug level setting of the DebugStream. The debug level on a DebugStream may be permanently set by using a SetDebugLevel( ) method, which sets the current debug level for outputs to the stream.

FIG. 7 is an exemplary program execution sequence for allowing direct access to the output stream in accordance with a preferred embodiment of the present invention. Given a class A function and an ostream& operator<<(ostream& os, A&) function, a DebugStream operator<<function may be implemented to control the original output function. In this illustrative example, a set of overloaded operator methods, class A function and a DebugStream operator<<function, are implemented for the common C++ types in step 702. Any other types, such as user classes, etc., would require additional, but simple, handling. In step 704, a determination is made as to whether the debug stream is enabled using an IsEnabled( ) method. If the debug stream is enabled, a mOS member of the DebugStream is used to provide a pointer to the actual output stream in step 706. As mentioned previously, the mOS member of the debug stream provides an output stream pointer member that allows direct access to the output stream when needed. Thus, the invocation of the mOS member calls the original output function in a way that is controlled by the debug streams framework. In this manner, the debug streams are as convenient to use as regular output streams.

For the most part, the decision of whether or not to output the trace is done at the highest level (as described above). Consequently, calls to traces should not have a significant impact on performance (e.g., compiler performance). However, in circumstances where some “heavy” computation needs to be performed for the purpose of outputting the trace, it would be a waste of time and resources to do that computation when the trace output is not needed. Under these circumstances, the users of the framework are encouraged to guard the computation with a call to an IsEnabled( ) method of the debug stream.

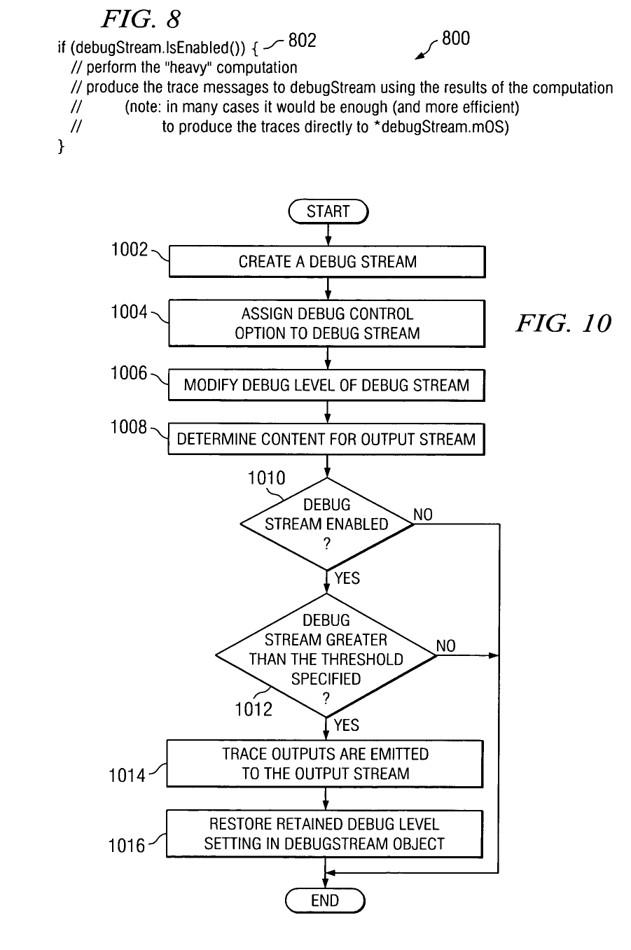

FIG. 8 is an exemplary program execution sequence for determining whether a debug stream is enabled for performance considerations in accordance with a preferred embodiment of the present invention. In this illustrative example, execution sequence 800 performs an IsEnabled( ) method 802 to test whether the debug stream output is enabled. IsEnabled( ) method 802 is used to determine the debug level and debug threshold conditions, the debug control option was supplied, and if there are any debug stream dependencies.

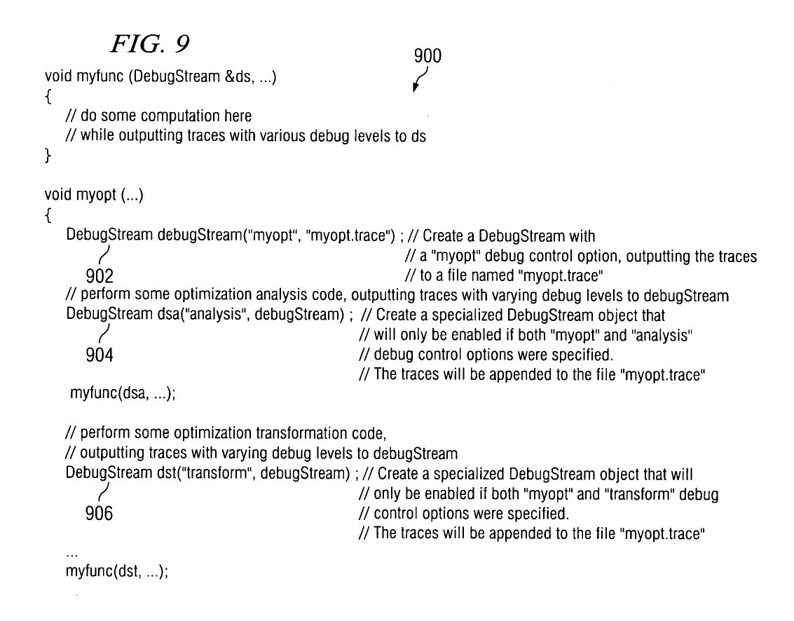

FIG. 9 is an exemplary program execution sequence for providing specialized trace streams in accordance with a preferred embodiment of the present invention. The specialized trace streams have a threshold level that is a maximum of their local threshold level and that of the debug stream they depend on. These specialized trace streams may be created using a debug stream constructor that specifies a DebugStream controller object, as described above. The output on this debug stream will be enabled if both its debug control option is enabled and the debug stream object is enabled.

In this illustrative example, a debug stream is created in step 902. The debug stream is created with a “myopt” debug control option. Output of the traces from the debug stream will be placed in a file named “myopt.trace”. As shown in step 904, optimization analysis code is then performed, and traces with varying debug levels are output to the debug stream. In this step, a specialized DebugStream object is created. This specialized DebugStream object is enabled only if both the “myopt” and “analysis” debug control options were specified. If both debug control options were specified, the trace output is appended to the “myopt.trace” file.

Next, optimization transformation code is performed in step 906. Traces with varying debug levels are output to the debug stream. In step 906, a specialized DebugStream object is created and enabled only if both the “myopt” and “transform” debug control options were specified. If both debug control options were specified, the trace output is appended to the “myopt.trace” file. In this manner, debug stream dependencies may be provided to trace specific parts of a code that is being generally traced. Tracing specific parts of a code allows for creating greater context sensitiveness beyond the absolute debug levels.

FIG. 10 is a flowchart depicting a process for using debug streams to control the amount of trace outputs in accordance with a preferred embodiment of the present invention. The process begins with creating a debug stream (step 1002). DebugStream( ) constructors that may be used to create a debug stream include a DebugStream( ) constructor that creates a debug stream, specifies a debug control option, and supplies a trace output stream, a DebugStream( ) constructor that creates a debug stream, specifies a debug control option, and specifies a file name, and a DebugStream( ) constructor that creates a debug stream, specifies a debug control option, and specifies a DebugStream controller object that allows for tracing specific parts of a code that is being generally traced.

When a DebugStream( ) constructor creates a debug stream instance, the debug stream is assigned a debug control option (step 1004). This debug control option is used to enable the debug stream. If specific trace messages are desired, the optional step of modifying the debug level of the debug stream may be performed (step 1006). A determination is then made as to the content for the output stream (step 1008). DebugStream object checks the debug stream to determine whether the debug stream is enabled (step 1010). If the debug stream is not enabled, no trace is output to the debug stream, and the process terminates thereafter.

If the debug stream is enabled, DebugStream object checks the debug stream to determine whether the current debug level setting in the debug stream is greater than a specified threshold (step 1012). The current debug level may be obtained using a GetDebugLevel( ) method, which queries the current debug level of the debug stream. If the current debug level is greater than the threshold specified, the trace outputs are not emitted to the output stream, and the process terminates thereafter.

However, if the current debug level is less than or equal to the threshold specified, trace outputs are emitted to the output stream (step 1014). The DebugLevel object restores the retained debug level setting in the DebugStream object when the DebugLevel object is deconstructed (step 1016), with the process terminating thereafter.

Thus, the present invention provides debug streams to control the amount of trace outputs when debugging software. As debug streams extend on the use of regular output streams, debug streams are very easy to use and simple to implement, while providing a high level of control over the verbosity of traces. Their design enables context sensitive tracing, which may be crucial in some scenarios, such as trying to analyze a problem in a very common part of the software.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for using debug streams to control the amount of trace outputs when debugging software, comprising:
creating a debug stream, wherein the debug stream includes a debug level setting to control a verbosity of the trace outputs;
determining whether the debug level setting in the debug stream is greater than a specified threshold level; and
responsive to a determination that the debug level setting is greater than the specified threshold level, emitting trace outputs to the debug stream.

2. The method of claim 1, further comprising:
responsive to a determination that the debug level setting is lower than the specified threshold level, omitting trace output to the debug stream.

3. The method of claim 1, further comprising:
temporarily modifying the debug level setting of the debug stream to a new debug level setting when the debug stream is created;
retaining the debug level setting using a DebugLevel object; and
restoring the debug level setting when the DebugLevel object is deconstructed.

4. The method of claim 1, further comprising:
permanently setting the debug level setting of the debug stream to a new debug level setting when the debug stream is created by deconstructing the DebugLevel object immediately before a DebugStream object is deconstructed.

5. The method of claim 1, wherein the debug stream is created using a debug stream constructor.

6. The method of claim 5, wherein the debug stream constructor creates the debug stream, specifies a debug control option, and supplies a trace output stream.

7. The method of claim 5, wherein the debug stream constructor creates the debug stream, specifies a debug control option, and specifies a file name.

8. The method of claim 7, wherein a trace output stream is written to a file with the file name.

9. The method of claim 5, wherein the debug stream constructor creates the debug stream, specifies a debug control option, and specifies a DebugStream controller object, wherein specifying a DebugStream controller object allows tracing specific parts of a code.

10. The method of claim 1, further comprising:
accessing a mOS member in the debug stream, wherein the mOS member provides direct access to an output stream by providing a pointer to the output stream.

11. The method of claim 1, wherein a GetThresholdLevel( ) method is used to obtain the threshold level of the debug stream.

12. The method of claim 11, wherein a DebugStream object provides direct access to the GetThresholdLevel( ) method and a mOS member, wherein the direct access increases software performance.

13. The method of claim 1, wherein a SetThresholdLevel( ) method is used to set the threshold level of the debug stream.

14. The method of claim 1, wherein a threshold is set for an entire stream.

15. A data processing system for using debug streams to control the amount of trace outputs when debugging software, comprising:
creating means for creating a debug stream, wherein the debug stream includes a debug level setting to control a verbosity of the trace outputs;
determining means for determining whether the debug level setting in the debug stream is greater than a specified threshold level; and
emitting means for emitting trace outputs to the debug stream in response to a determination that the debug level setting is greater than the specified threshold level.

16. The data processing system of claim 15, further comprising:
omitting means for omitting trace output to the debug stream in response to a determination that the debug level setting is lower than the specified threshold level.

17. The data processing system of claim 15, further comprising:
modifying means for temporarily modifying the debug level setting of the debug stream to a new debug level setting when the debug stream is created;
retaining means for retaining the debug level setting using a DebugLevel object; and
restoring means for restoring the debug level setting when the DebugLevel object is deconstructed.

18. The data processing system of claim 15, further comprising:
setting means for permanently setting the debug level setting of the debug stream to a new debug level setting when the debug stream is created by deconstructing the DebugLevel object after a DebugStream object is deconstructed.

19. The data processing system of claim 15, wherein the debug stream is created using a debug stream constructor.

20. The data processing system of claim 19, wherein the debug stream constructor creates the debug stream, specifies a debug control option, and supplies a trace output stream.

21. The data processing system of claim 19, wherein the debug stream constructor creates the debug stream, specifies a debug control option, and specifies a file name.

22. The data processing system of claim 20, wherein a trace output stream is written to a file with the file name.

23. The data processing system of claim 19, wherein the debug stream constructor creates the debug stream, specifies a debug control option, and specifies a DebugStream controller object, wherein specifying a DebugStream controller object allows tracing specific parts of a code.

24. The data processing system of claim 15, further comprising:
accessing a mOS member in the debug stream, wherein the mOS member provides direct access to an output stream by providing a pointer to the output stream.

25. The data processing system of claim 15, wherein a GetThresholdLevel( ) method is used to obtain the threshold level of the debug stream.

26. The data processing system of claim 25, wherein a DebugStream object provides direct access to the GetThresholdLevel( ) method and a mOS member, wherein the direct access increases software performance.

27. The data processing system of claim 15, wherein a SetThresholdLevel( ) method is used to set the threshold level of the debug stream.

28. The data processing system of claim 15, wherein a threshold is set for an entire stream.

29. A computer program product in a computer readable medium for using debug streams to control the amount of trace outputs when debugging software, comprising:
first instructions for creating a debug stream, wherein the debug stream includes a debug level setting to control a verbosity of the trace outputs;
second instructions for determining whether the debug level setting in the debug stream is greater than a specified threshold level; and
third instructions for emitting trace outputs to the debug stream in response to a determination that the debug level setting is greater than the specified threshold level.

30. The computer program product of claim 29, further comprising:
fourth instructions for omitting trace output to the debug stream in response to a determination that the debug level setting is lower than the specified threshold level.

31. The computer program product of claim 29, further comprising:
fourth instructions for temporarily modifying the debug level setting of the debug stream to a new debug level setting when the debug stream is created;
fifth instructions for retaining the debug level setting using a DebugLevel object; and
sixth instructions for restoring the debug level setting when the DebugLevel object is deconstructed.

32. The computer program product of claim 29, further comprising:
fourth instructions for permanently setting the debug level setting of the debug stream to a new debug level setting when the debug stream is created by deconstructing the DebugLevel object after a DebugStream object is deconstructed.

33. The computer program product of claim 29, wherein the debug stream is created using a debug stream constructor.

34. The computer program product of claim 33, wherein the debug stream constructor creates the debug stream, specifies a debug control option, and supplies a trace output stream.

35. The computer program product of claim 33, wherein the debug stream constructor creates the debug stream, specifies a debug control option, and specifies a file name.

36. The computer program product of claim 33, wherein a trace output stream is written to a file with the file name.

37. The computer program product of claim 33, wherein the debug stream constructor creates the debug stream, specifies a debug control option, and specifies a DebugStream controller object, wherein specifying a DebugStream controller object allows tracing specific parts of a code.

38. The computer program product of claim 29, further comprising:
accessing a mOS member in the debug stream, wherein the mOS member provides direct access to an output stream by providing a pointer to the output stream.

39. The computer program product of claim 29, wherein a GetThresholdLevel( ) method is used to obtain the threshold level of the debug stream.

40. The computer program product of claim 39, wherein a DebugStream object provides direct access to the GetThresholdLevel( ) method and a mOS member, wherein the direct access increases software performance.

41. The computer program product of claim 29, wherein a SetThresholdLevel( ) method is used to set the threshold level of the debug stream.

42. The computer program product of claim 29, wherein a threshold is set for an entire stream.
